(19) United States
(12) Patent Application Publication
(10) Pub. No.: US 2026/0014491 A1
(43) Pub. Date: Jan. 15, 2026

(54) LIGHTING TOY

(71) Applicant: EPOCH COMPANY, LTD., Tokyo (JP)

(72) Inventor: Kei KAMIYAMA, Tokyo (JP)

(73) Assignee: EPOCH COMPANY, LTD., Tokyo (JP)

(21) Appl. No.: 19/266,760

(22) Filed: Jul. 11, 2025

(30) Foreign Application Priority Data
Jul. 12, 2024 (JP) 2024-112354

(51) Int. Cl. A63H 33/22; A63H 3/52

(52) U.S. Cl. CPC A63H 33/22; A63H 3/52

(57) ABSTRACT

The lighting toy includes a light guide body configured to guide light from an outside. The light guide body includes: a light collecting portion configured to collect the light; a reflection portion configured to reflect the light incident on the light collecting portion to change a traveling direction of the light to a predetermined direction; and a lighting portion to which the light reflected by the reflection portion reaches.

### CROSS-REFERENCE TO RELATED APPLICATIONS

This application is based on and claims priority under 35 USC 119 from Japanese Patent Application No. 2024-112354 filed on Jul. 12, 2024, the contents of which are incorporated herein by reference.

### TECHNICAL FIELD

The present disclosure relates to a lighting toy.

### BACKGROUND ART

In the related art, as disclosed in JP3213871U, an illumination toy including a light source is known. In the illumination toy of a building toy disclosed in JP3213871U, the light source emits light by receiving electric power supplied from a battery.

### SUMMARY OF INVENTION

However, in the toy disclosed in JP3213871U, as described above, since the light source emits light by receiving electric power supplied from the battery, there are problems such as light emission failure due to battery exhaustion, and cost and labor for replacing the battery with a new one.

An object of the present disclosure is to provide a lighting toy capable of avoiding light emission failure due to battery exhaustion or the like and cost generation.

A lighting toy according to an embodiment of the present disclosure includes: a light guide body configured to guide light from outside, in which the light guide body includes: a light collecting portion configured to collect the light; a reflection portion configured to reflect the light incident on the light collecting portion to change a traveling direction of the light to a predetermined direction; and a lighting portion to which the light reflected by the reflection portion reaches.

According to the above configuration, it is possible to avoid light emission failure due to battery exhaustion or the like and cost generation.

### BRIEF DESCRIPTION OF DRAWINGS

The present disclosure will be described in detail based on the following without being limited thereto, wherein:

FIG. 1 is a perspective view illustrating an overall configuration of a building toy including a lighting toy according to an embodiment of the present disclosure;

FIG. 2 is a rear view of the building toy illustrated in FIG. 1;

FIG. 3 is a diagram (part 1) illustrating a detailed configuration of an illumination toy illustrated in FIG. 2;

FIG. 4 is a diagram (part 2) illustrating a detailed configuration of the illumination toy illustrated in FIG. 2;

FIG. 5 is a diagram illustrating a detailed configuration of a light guide body illustrated in FIG. 3;

FIGS. 6A and 6B are diagrams, each illustrating a traveling direction of light in the light guide body illustrated in FIG. 5 and brightness of a lighting portion according to an area of a reflection portion;

FIGS. 7A and 7B are diagrams (part 1), each illustrating a desirable configuration of the light guide body illustrated in FIGS. 6A and 6B;

FIGS. 8A to 8D are diagrams (part 2) for illustrating desirable configurations of the light guide body illustrated in FIGS. 6A and 6B;

FIGS. 9A to 9C are diagrams for illustrating a desirable configuration of the light guide body and a cover portion illustrated in FIG. 3;

FIG. 10 is a diagram illustrating a desirable installation position of the light guide body illustrated in FIG. 5;

FIG. 11 is a diagram illustrates a modification (part 1) of the light guide body illustrated in FIG. 5;

FIG. 12 is a diagram illustrating a modification (part 2) of the light guide body illustrated in FIG. 5;

FIG. 13 is a diagram illustrating a modification (part 3) of the light guide body illustrated in FIG. 5;

FIG. 14 is a perspective view illustrating an overall configuration of a vehicle toy including the lighting toy according to the embodiment of the present disclosure;

FIG. 15 is a diagram illustrating a detailed configuration of an illumination toy illustrated in FIG. 14;

FIG. 16 is a diagram illustrating an overall configuration of a cave toy including the lighting toy according to the embodiment of the present disclosure;

FIG. 17 is a diagram illustrating a detailed configuration of a light guide body illustrated in FIG. 16;

FIG. 18 is a diagram (part 1) illustrating a configuration for changing a light emission state of a lighting portion illustrated in FIG. 16;

FIGS. 19A and 19B are diagrams (part 2) illustrating a configuration for changing the light emission state of the lighting portion illustrated in FIG. 16; and

FIG. 20 is a diagram illustrating a configuration for causing the lighting portion illustrated in FIG. 16 to emit light in a predetermined color.

### DESCRIPTION OF EMBODIMENTS

Hereinafter, an embodiment of the present disclosure will be described in detail with reference to the drawings. In the following description, the same components are denoted by the same reference numerals, and the names and functions thereof are the same. Therefore, detailed description thereof will not be repeated.

In the following description, the terms “front”, “back”, “left”, “right”, “up”, and “down” may be used, but these directions are relative directions set for convenience of description. In each drawing, “F” represents “front”, “B” represents “back”, “L” represents “left”, “R” represents “right”, “U” represents “up”, and “D” represents “down”.

### [Configuration of Toy Including Lighting Toy]

### (Overall Configuration of Building Toy)

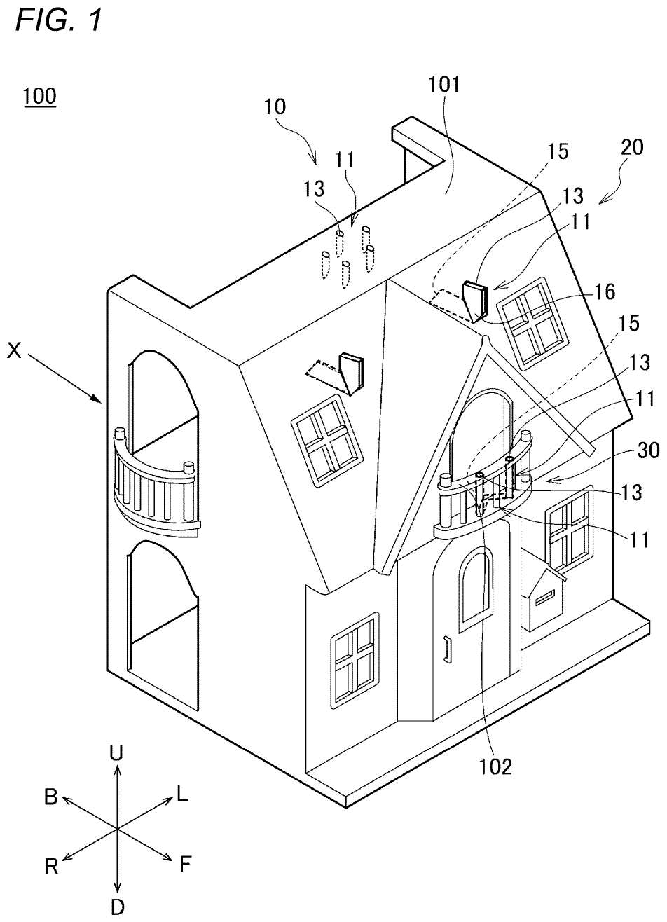

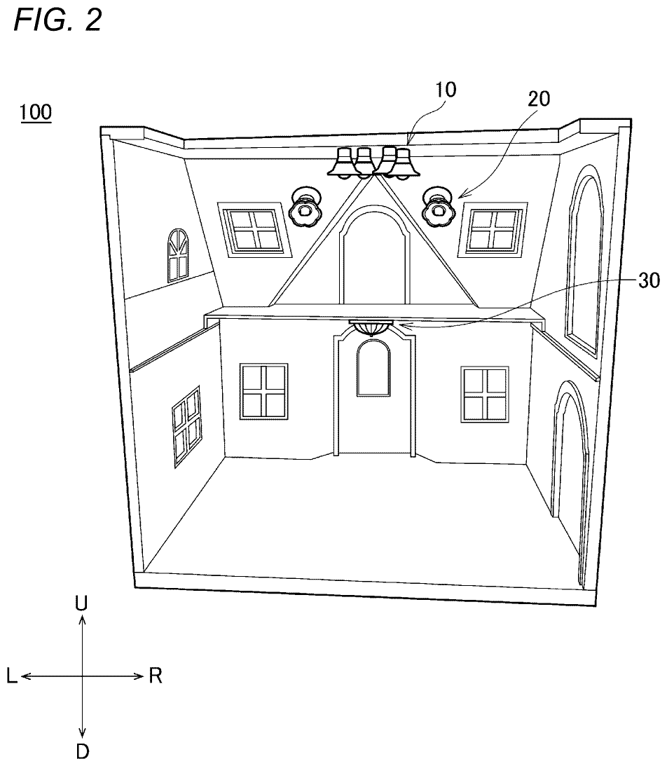

Here, a building toy 100 will be described as an example of a toy including a lighting toy according to an embodiment of the present disclosure. FIG. 1 is a perspective view illustrating an overall configuration of a building toy 100 including a lighting toy according to an embodiment of the present disclosure. FIG. 2 is a rear view of the building toy 100 illustrated in FIG. 1.

Referring to FIGS. 1 and 2, the building toy 100 is a toy imitating a two-story building, and has an open rear side (back side). A player can place a toy or the like imitating furniture inside the building toy 100 from the rear side of the building toy 100 and play with dolls. The building toy 100 is provided with illumination toys 10, 20, and 30, which are examples of the lighting toy.

More specifically, referring to FIG. 2, the illumination toys 10 and 20 are attached to a roof 101 of the building toy 100. The illumination toy 30 is attached to a ceiling of a first floor of the building toy 100. The illumination toy 10 is a toy imitating a multi-lamp lighting fixture such as a chandelier. The illumination toy 20 is a toy imitating a single-lamp lighting fixture such as a bracket light. The illumination toy 30 is a toy imitating a lighting fixture having a relatively large light emission range such as a ceiling light.

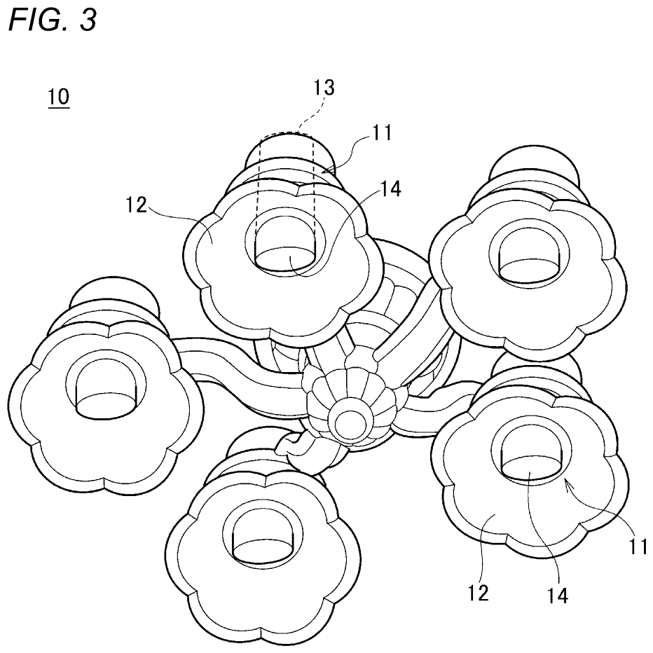

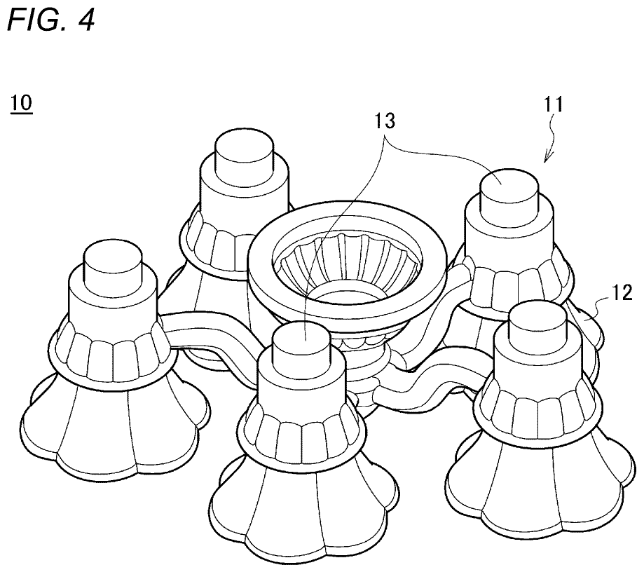

FIGS. 3 and 4 are diagrams each illustrating a detailed configuration of the illumination toy 10 illustrated in FIG. 2. The illumination toy 10 includes a plurality of sets of a light guide body 11 and a cover portion 12 provided to cover a part of the light guide body 11. The light guide body 11 is attached to, for example, the roof 101 of the building toy 100 as illustrated in FIG. 1. The light guide body 11 is formed of, for example, a transparent resin such as an acrylic resin or general-purpose polystyrene, and guides light from an indoor light in a room where the building toy 100 is placed or light from an outside such as sunlight.

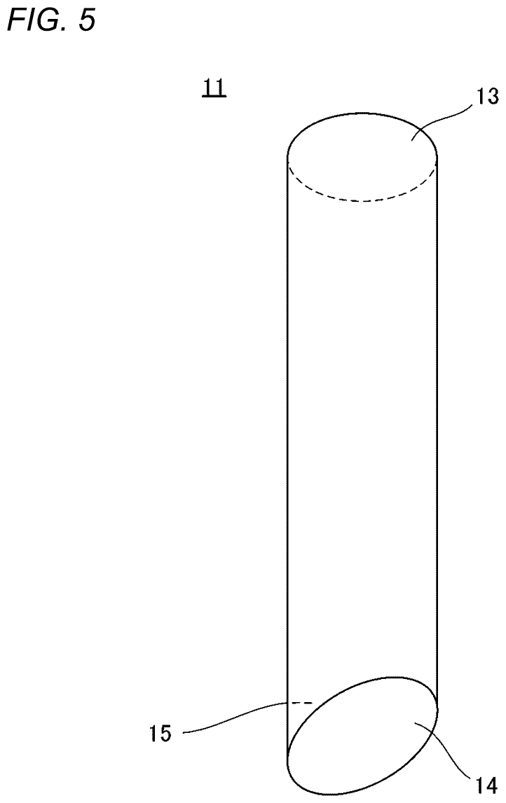

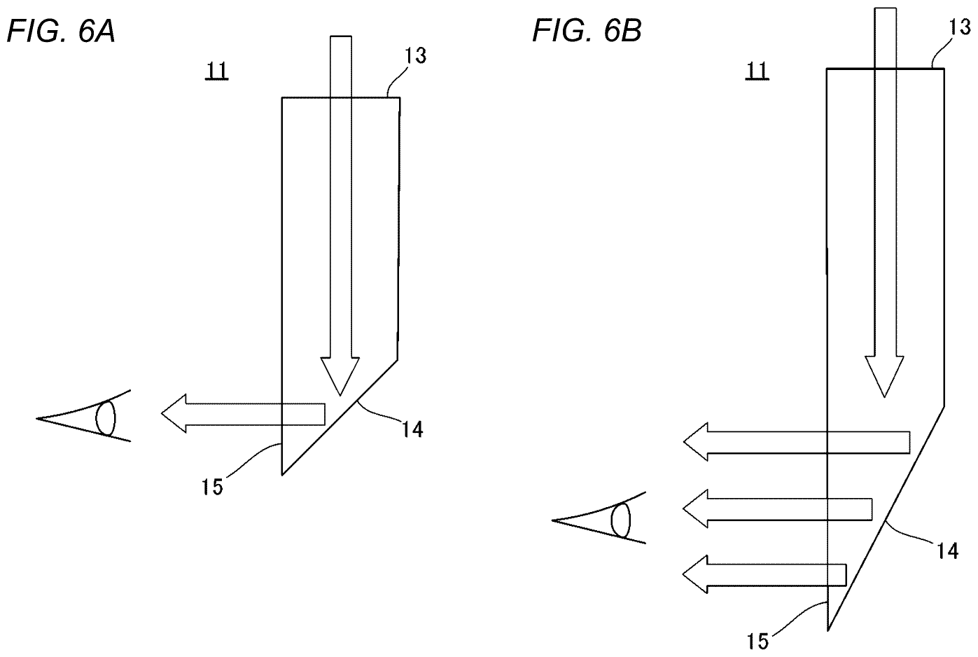

FIG. 5 is a diagram illustrating a detailed configuration of the light guide body 11 illustrated in FIG. 3. FIGS. 6A and 6B are diagrams, each illustrating a traveling direction of light in the light guide body 11 illustrated in FIG. 5 and brightness of a lighting portion 15 according to an area of a reflection portion 14. Referring to FIG. 5 and FIGS. 6A and 6B, the light guide body 11 includes a light collecting portion 13 having, for example, a cylindrical shape, and the reflection portion 14 that is a surface inclined with respect to an extending direction of the light collecting portion 13 and intersecting the extending direction.

For example, an upper end of the light collecting portion 13 is exposed from the roof 101 of the building toy 100 (see FIG. 1), and the light collecting portion 13 configured to collect light from the outside. Then, the light incident on the light collecting portion 13 is guided to the reflection portion 14. The reflection portion 14 reflects the light from the outside incident on the light collecting portion 13 and changes the traveling direction of the light to a predetermined direction. As illustrated in FIG. 6A, the light guide body 11 includes the lighting portion 15 facing the reflection portion 14 in addition to the light collecting portion 13 and the reflection portion 14. The light reflected by the reflection portion 14 reaches the lighting portion 15. With such a configuration, it is possible to cause the lighting portion 15 to emit light using external light without receiving electric power supplied from a battery or the like.

In the illumination toys 10, 20, and 30 illustrated in FIG. 1, each light guide body 11 is attached such that the lighting portion 15 faces in a main visual line direction when the player plays with the building toy 100, that is, a direction (X-direction illustrated in FIG. 1) in which the inside of the building toy 100 is viewed from the rear surface of the building toy 100. Accordingly, when playing with the building toy 100, it is possible to more reliably see a state in which each lighting portion 15 of the illumination toys 10, 20, and 30 emits light.

As illustrated in FIG. 6B, when the area of the reflection portion 14 is formed to be large, a range of the lighting portion 15 can be widened, so that the player can perceive light more intensely. In addition, the light guide body 11 may be implemented to increase the amount of light reaching the lighting portion 15 by increasing a reflectance of light in the reflection portion 14 by performing plating processing such as a mirror on the reflection portion 14.

### (Desirable Configuration of Light Guide Body)

### (a) Surface Area of Light Collecting Portion

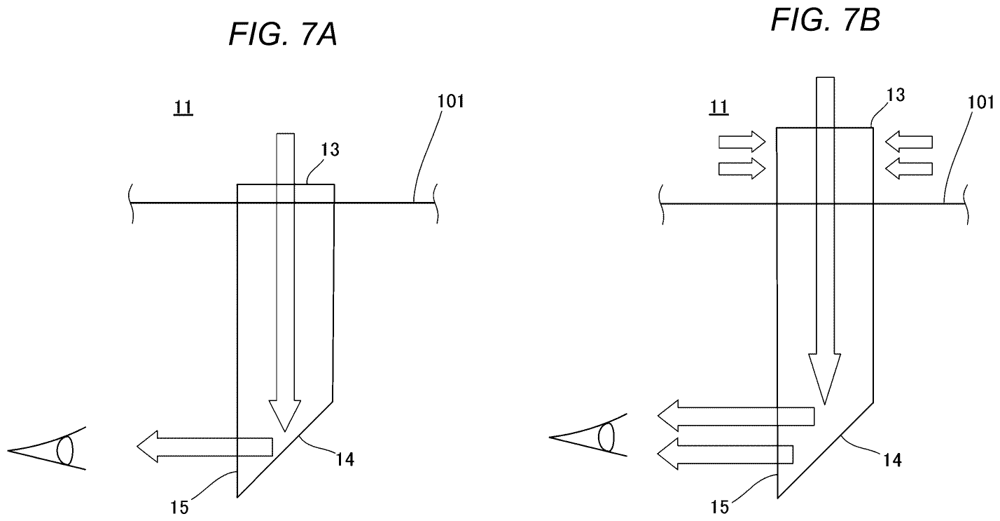

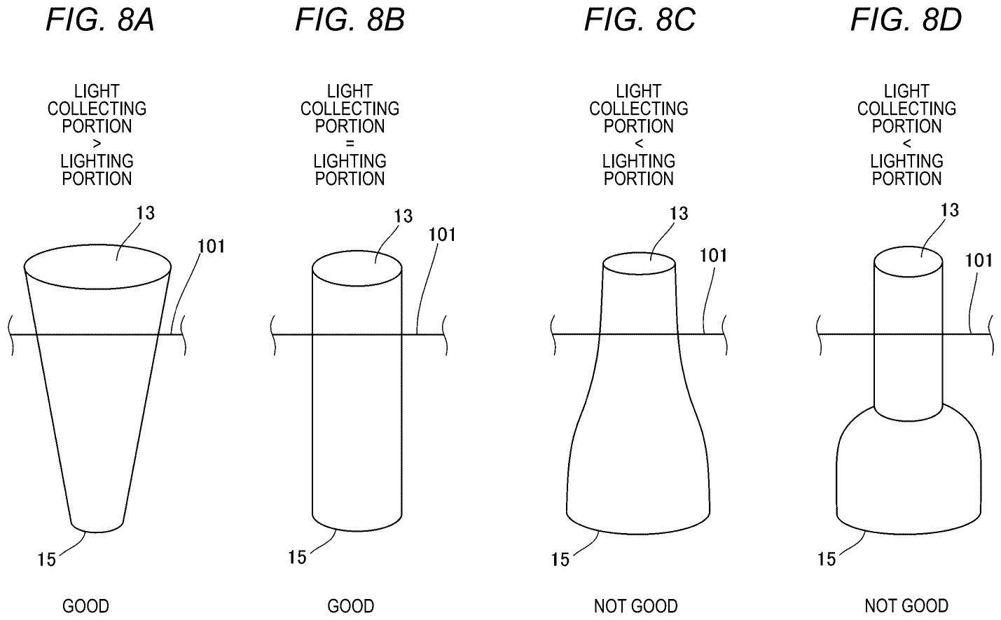

FIGS. 7A and 7B and FIGS. 8A to 8D are diagrams for illustrating desirable configurations of the light guide body 11 illustrated in FIGS. 6A and 6B. The length of the light guide body 11 exposed from the roof 101 illustrated in FIG. 1 differs between the light guide body 11 illustrated in FIG. 7A and the light guide body 11 illustrated in FIG. 7B. For example, as illustrated in FIG. 7B, a surface area of the light collecting portion 13 in contact with external light is increased by lengthening a portion of the light guide body 11 exposed from the roof 101. With such a configuration, since the amount of light incident on the light collecting portion 13 can be increased, the lighting portion 15 can be made brighter. In addition, the amount of light incident on the light collecting portion 13 may be increased by increasing a diameter of the light collecting portion 13.

### (b) Relation Between Areas of Light Collecting Portion and Lighting Portion

As illustrated in FIG. 8C and FIG. 8D, when an area of an end portion (an example of a first end portion) of the light guide body 11 on a light collecting portion 13 side is smaller than an area of an end portion (an example of a second end portion) on a lighting portion 15 side, an intensity of light at the end portion on the lighting portion 15 side is smaller than an intensity of light at the end portion on the light collecting portion 13 side. In contrast, as illustrated in FIG. 8A and FIG. 8B, when the area of the end portion of the light guide body 11 on the light collecting portion 13 side is equal to or larger than the area of the end portion on the lighting portion 15 side, the amount of light per unit area of the lighting portion 15 can be sufficiently secured. Therefore, with such a configuration, the lighting portion 15 can be made brighter.

### (c) Relation Between Light Guide Body and Cover Portion

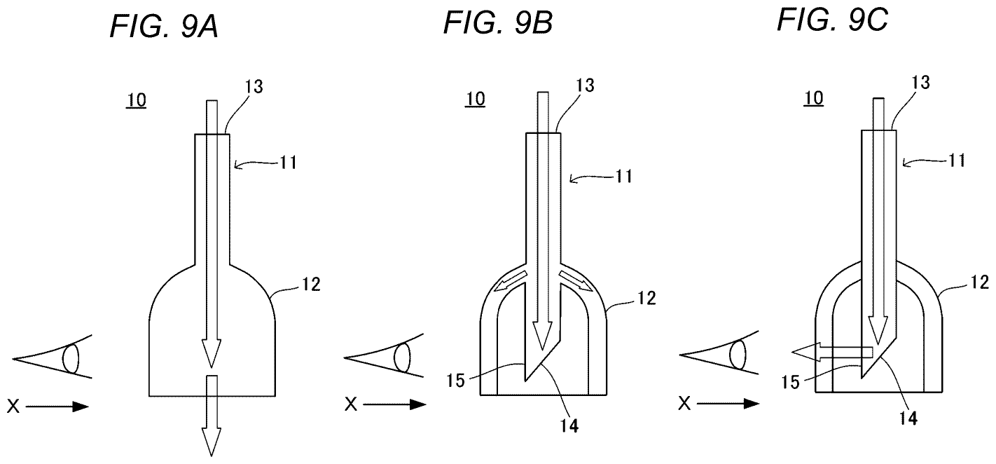

FIGS. 9A to 9C are diagrams for illustrating a desirable configuration of the light guide body 11 and the cover portion 12 illustrated in FIG. 3. In a case in which the light guide body 11 does not include the reflection portion 14 and the light guide body 11 and the cover portion 12 are integrally formed as illustrated in FIG. 9A, the light incident on the light collecting portion 13 travels along the extending direction of the light guide body 11. Therefore, when the illumination toy 10 is viewed from the X-direction illustrated in FIG. 9A, it is difficult to see that a portion corresponding to a light bulb of the illumination toy 10 emits light.

In addition, in a case in which the light guide body 11 includes the reflection portion 14 but the light guide body 11 and the cover portion 12 are integrally formed as illustrated in FIG. 9B, the light incident on the light collecting portion 13 is dispersed to the cover portion 12 and the reflection portion 14. Therefore, when the illumination toy 10 is viewed from the X-direction illustrated in FIG. 9B, the brightness of the lighting portion 15 cannot be sufficiently secured.

Meanwhile, in a case in which the light guide body 11 and the cover portion 12 are formed separately as illustrated in FIG. 9C, the light incident on the light collecting portion 13 is more reliably changed in the traveling direction in the reflection portion 14 and reaches the lighting portion 15. Accordingly, when the illumination toy 10 is viewed from the X-direction, the lighting portion 15 corresponding to the light bulb of the illumination toy 10 looks brighter than other portions.

As illustrated in FIGS. 2 and 3, when the lighting toy is used in an illumination toy such as the illumination toy 10, the shape of the lighting portion 15 of the light guide body 11 is preferably circular. With such a configuration, it is possible to make the lighting portion 15 look like a light bulb.

### (d) Attachment of Light Guide Body

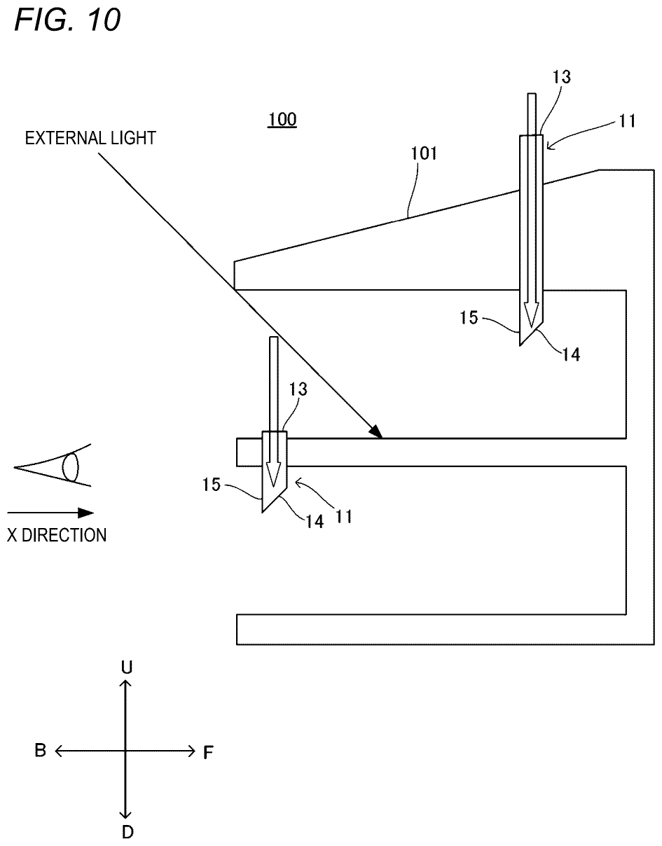

FIG. 10 is a diagram illustrating a desirable installation position of the light guide body 11 illustrated in FIG. 5. The light guide body 11 is desirably provided such that the end portion on the light collecting portion 13 side faces upward and the end portion (that is, the upper end) is exposed without being hidden by another member. Accordingly, external light such as from the indoor light is easily incident on the light collecting portion 13.

In addition, it is desirable that the lighting portion 15 is installed at a position where a part of light from the outside is blocked. Accordingly, the periphery of the lighting portion 15 is darker than other positions, and thus the brightness of the lighting portion 15 is emphasized.

Specifically, as illustrated in FIG. 10, when the light guide body 11 is provided on the roof 101 of the building toy 100, for example, the light guide body 11 is provided such that the light collecting portion 13 is exposed from the roof 101 and the lighting portion 15 is positioned below the roof 101. When the light guide body 11 is provided on the ceiling of the first floor of the building toy 100, for example, the light guide body 11 is provided such that the light collecting portion 13 is exposed to the upper rear side of the ceiling and the lighting portion 15 is positioned below the ceiling.

### Modifications of Light Guide Body

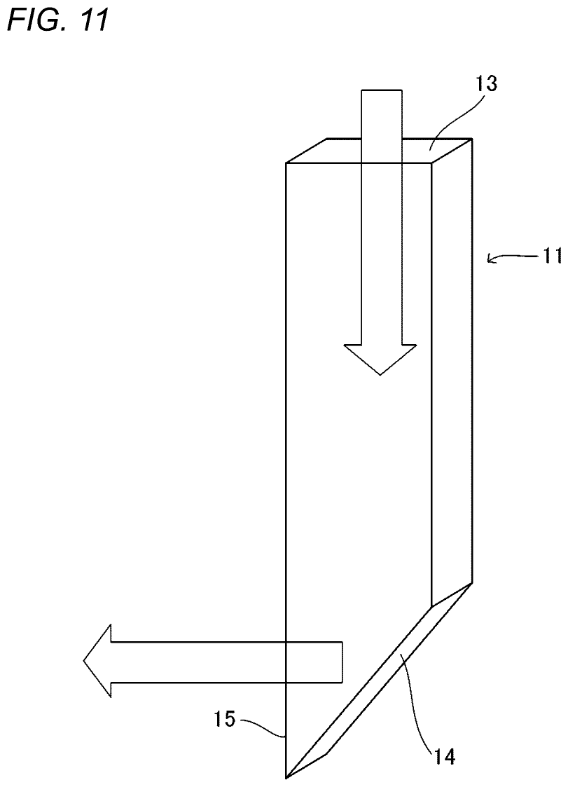

FIG. 11 is a diagram illustrates a modification (part 1) of the light guide body 11 illustrated in FIG. 5. The shape of the light collecting portion 13 in the light guide body 11 is not limited to a cylinder, and may be a quadrangular prism as illustrated in FIG. 11. When the shape of the light collecting portion 13 is a quadrangular prism, the light collecting portion 13 can be easily formed as compared with a case in which the shape of the light collecting portion 13 is a cylinder, and a large surface area of the light collecting portion 13 can be secured.

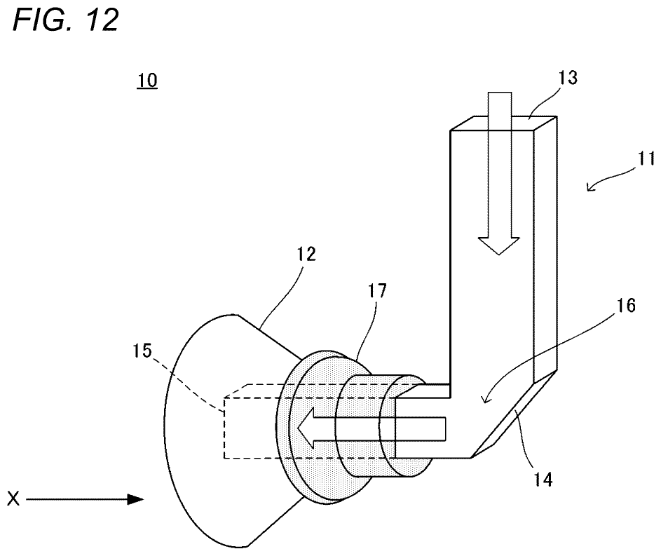

FIG. 12 is a diagram illustrating a modification (part 2) of the light guide body 11 illustrated in FIG. 5. The light guide body 11 may include a bent portion 16 between the light collecting portion 13 and the lighting portion 15. In this case, the reflection portion 14, which is an inclined surface, is provided on an outer side of an inner wall of the bent portion 16. In other words, on at least a part of the bent portion 16 on an outer side in its bending direction, the reflection portion 14 is provided. With such a configuration, the position of the light collecting portion 13 and the position of the lighting portion 15 can be separately provided in the X-direction illustrated in FIG. 12.

Specifically, in the illumination toy 20 illustrated in FIG. 1, the light guide body 11 including the bent portion 16 as illustrated in FIG. 12 is used. Therefore, for example, as illustrated in FIG. 2, the lighting portion 15 can be installed at any position, such as installing the light collecting portion 13 on a front side of the roof 101 of the building toy 100 and installing the lighting portion 15 so as to protrude to a back side of the roof 101.

In the illumination toy 10 illustrated in FIG. 12, a socket cover portion 17 for shielding light from the outside is attached to the lighting portion 15 side of the light guide body 11. Accordingly, the periphery of the light guide body 11 on the lighting portion 15 side becomes relatively dark inside the socket cover portion 17. Therefore, when viewed from the X-direction, a difference in brightness between the periphery of the lighting portion 15 and the lighting portion 15 increases, and the lighting portion 15 looks brighter.

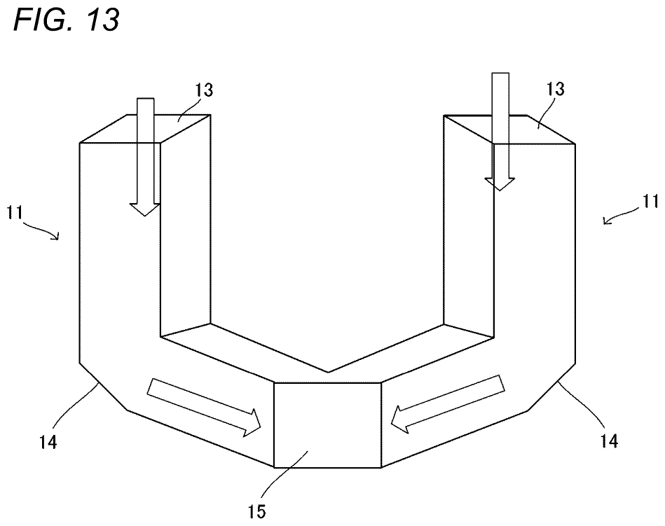

FIG. 13 is a diagram illustrating a modification (part 3) of the light guide body 11 illustrated in FIG. 5. As illustrated in FIG. 13, a plurality of light guide bodies 11 having a common lighting portion 15 may be connected. Specifically, in the illumination toy 30 illustrated in FIGS. 1 and 2, two light guide bodies 11 are provided on a handrail 102 (see FIG. 1) of the building toy 100 as illustrated in FIG. 13, and these two light guide bodies 11 are connected so that the respective lighting portions 15 are common. As a result, the total surface area of the light collecting portion 13 can be ensured to be large, and thus the intensity of light of the lighting portion 15 can be increased.

### [Another Example of Toy Including Lighting Toy (Part 1)]

### (Overall Configuration of Vehicle Toy)

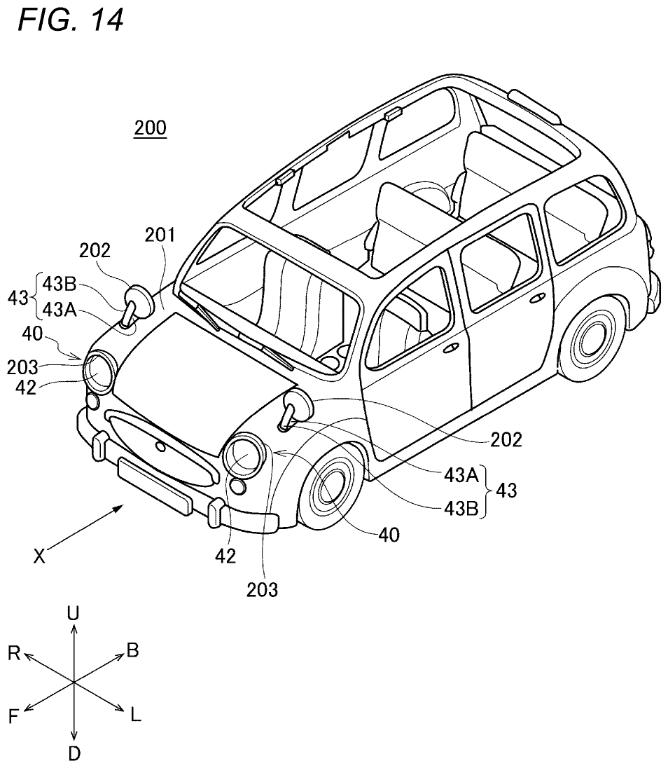

Next, a vehicle toy 200 will be described as another example of the toy including the lighting toy according to the embodiment of the present disclosure. FIG. 14 is a perspective view illustrating an overall configuration of the vehicle toy 200 including the lighting toy according to the embodiment of the present disclosure. The vehicle toy 200 is, for example, a toy imitating a car, and illumination toys 40 each as an example of the lighting toy are provided at positions corresponding to left and right headlights.

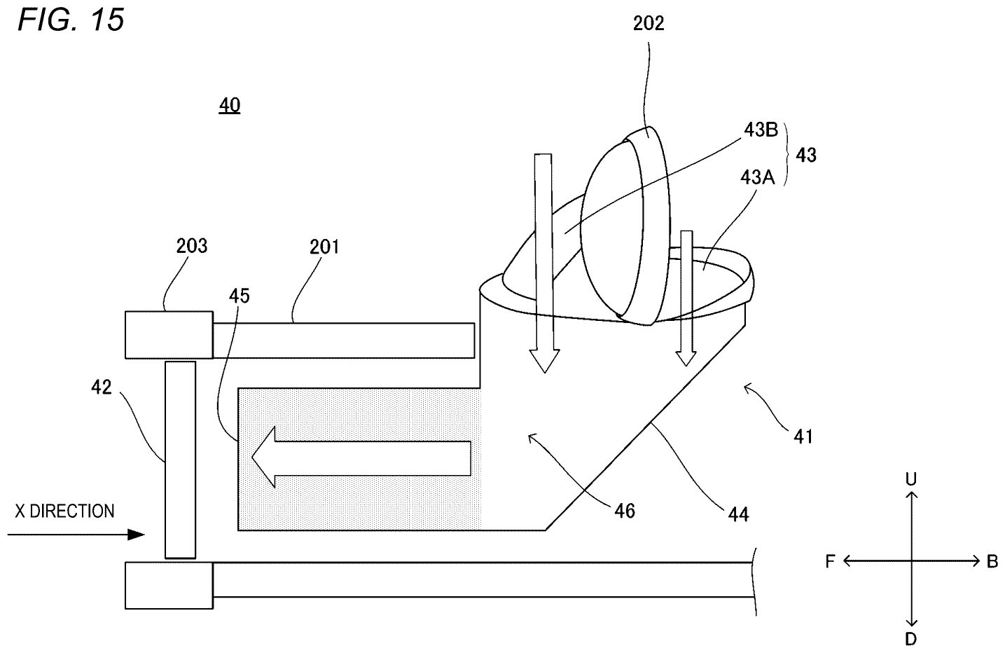

FIG. 15 is a diagram illustrating a detailed configuration of the illumination toy 40 illustrated in FIG. 14. The illumination toy 40 includes a light guide body 41 and a cover portion 42. The light guide body 41 includes a light collecting portion 43, a reflection portion 44, a lighting portion 45, and a bent portion 46. The reflection portion 44, the lighting portion 45, and the bent portion 46 have the same configurations as the reflection portion 14, the lighting portion 15, and the bent portion 16 illustrated in FIG. 12, respectively.

The light collecting portion 43 includes, for example, a light collecting body portion 43A having a cylindrical shape and a mirror support portion 43B that supports a side mirror 202 of the vehicle toy 200. More specifically, in a bonnet 201 (see FIG. 14) of the vehicle toy 200, an opening is formed near the side mirror 202, and the light collecting body portion 43A is provided inside the opening. In addition, an upper end of the light collecting body portion 43A is exposed from the opening.

The mirror support portion 43B is formed integrally with the light collecting body portion 43A using, for example, the same material as the light collecting body portion 43A, and functions as a part of the light collecting portion 43. As described above, since both the light collecting body portion 43A and the mirror support portion 43B serve as the light collecting portion 43, a surface area of the light collecting portion 43 can be increased.

The lighting portion 45 is provided at a position corresponding to the headlight of the vehicle toy 200. The cover portion 42 is provided to cover the lighting portion 45 in front of the lighting portion 45. Therefore, when viewed from the X-direction illustrated in FIG. 14, the headlight of the vehicle toy 200 appears to be turned on behind the cover portion 42.

In the vehicle toy 200 illustrated in FIG. 14, an eaves portion 203 protruding forward from the lighting portion 45 is provided around the lighting portion 45. Since the eaves portion 203 is provided and the light guide body 41 is positioned inside the bonnet 201, the periphery of the light guide body 41 on a lighting portion 45 side (hatched portion in FIG. 15) is relatively dark. Therefore, when viewed from the X-direction, a difference in brightness between the periphery of the lighting portion 45 and the lighting portion 45 increases, and the lighting portion 45 looks brighter.

The shape of the light collecting body portion 43A is not limited to a cylinder, and may be a quadrangular prism or the like. A part of the side mirror 202 may be implemented as the light collecting portion 43. Further, the mirror support portion 43B may not be included in the light collecting portion 43.

### [Another Example of Toy Including Lighting Toy (Part 2)]

### (Overall Configuration of Cave Toy)

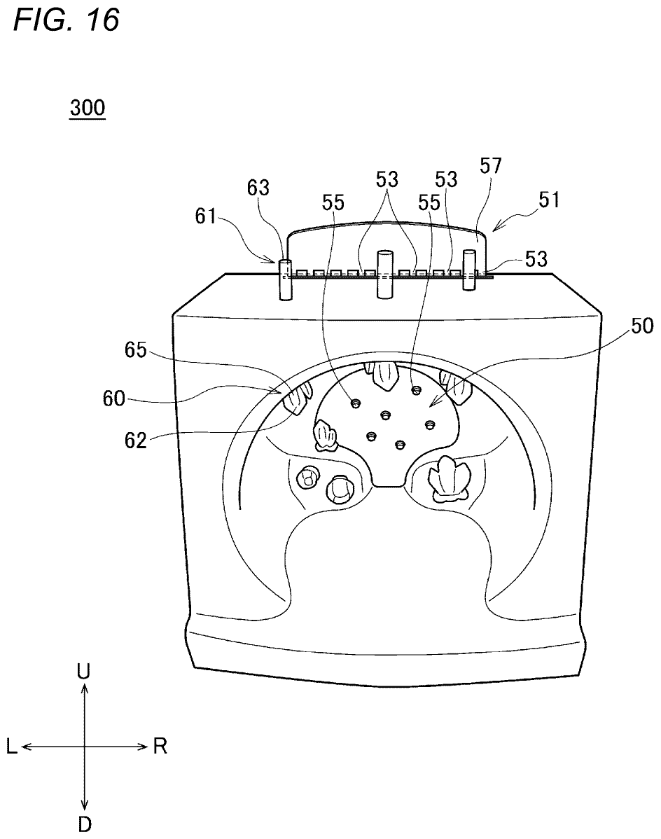

Next, a cave toy 300 will be described as another example of the toy including the lighting toy according to the embodiment of the present disclosure. FIG. 16 is a diagram illustrating an overall configuration of the cave toy 300 including the lighting toy according to the embodiment of the present disclosure. The cave toy 300 is a toy imitating the inside of a cave, and is provided with jewel toys 50 and 60 each imitating a jewel as an example of the lighting toy.

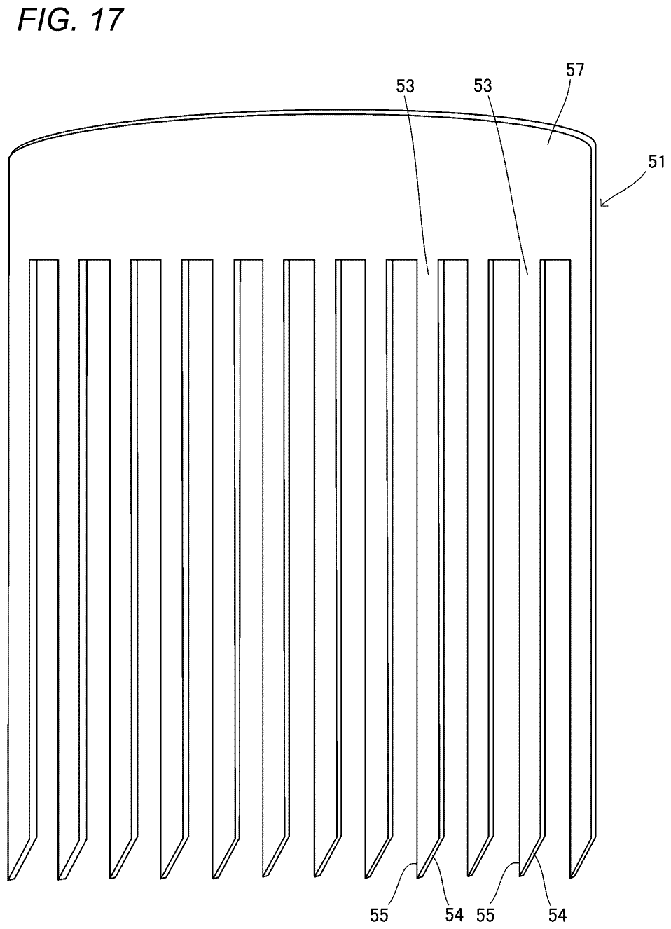

The jewel toy 50 includes a light guide body 51 provided on an upper portion of the cave toy 300. FIG. 17 is a diagram illustrating a detailed configuration of the light guide body 51 illustrated in FIG. 16. As illustrated in FIG. 17, the light guide body 51 includes, for example, a plurality of light collecting portions 53, reflection portions 54 each reflecting light incident on each light collecting portion 53, lighting portions 55 to which light reflected by each reflection portion 54 reaches, and a connection portion 57 that connects the plurality of light collecting portions 53.

The connection portion 57 is formed of, for example, the same material as the light guide body 51, and connects upper ends of the light collecting portions 53 of the light guide body 51. In this way, by connecting the plurality of light collecting portions 53 by the connection portion 57, the amount of light incident on the light guide body 51 can be increased, and the number of attachment steps of the light guide body 51 can be reduced.

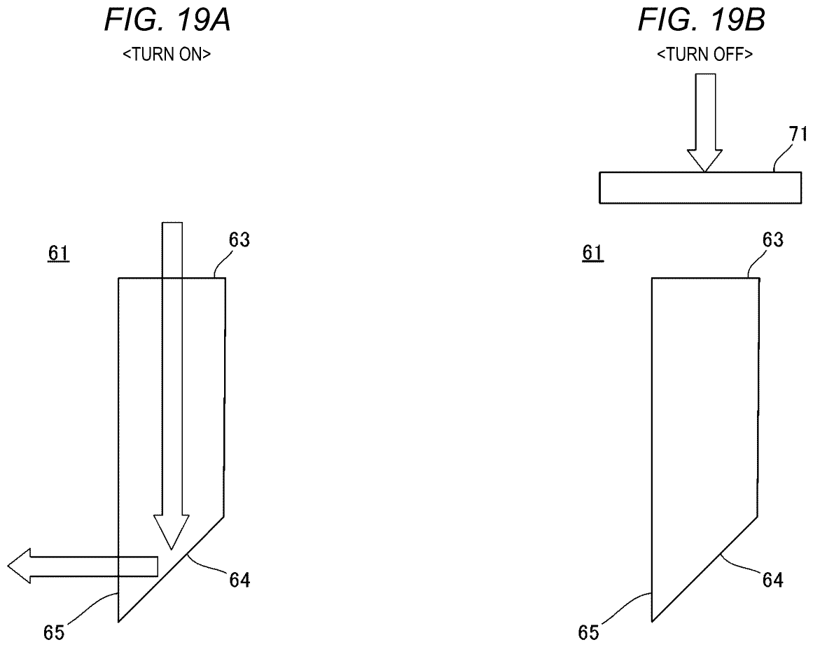

Referring again to FIG. 16, the jewel toy 60 includes a light guide body 61 provided on an upper portion of the cave toy 300 and a cover portion 62. For example, similarly to the light guide body 11 illustrated in FIG. 5, the light guide body 61 includes a light collecting portion 63 exposed from the upper portion of the cave toy 300, a reflection portion 64 (see FIGS. 19A and 19B) that reflects light incident on the light collecting portion 63, and a lighting portion 65 to which the light reflected by the reflection portion 64 reaches.

The cover portion 62 is formed of a material that allows light to transmit therethrough, and has a shape imitating a jewel. The cover portion 62 is attached so as to cover the lighting portion 65. It is desirable that the light guide body 61 and the cover portion 62 are formed separately, similarly to the light guide body 11 and the cover portion 12 illustrated in FIG. 9C. The cover portion 62 may be colored.

The lighting portion 55 of the jewel toy 50 and the lighting portion 65 of the jewel toy 60 are provided inside the cave toy 300 where a part of light from the outside is blocked. Accordingly, the periphery of the lighting portion 55 or 65 becomes darker than other portions, and thus the brightness of the lighting portion 55 or 65 is emphasized.

### (Configuration for Changing Light Emission State of Lighting Portion)

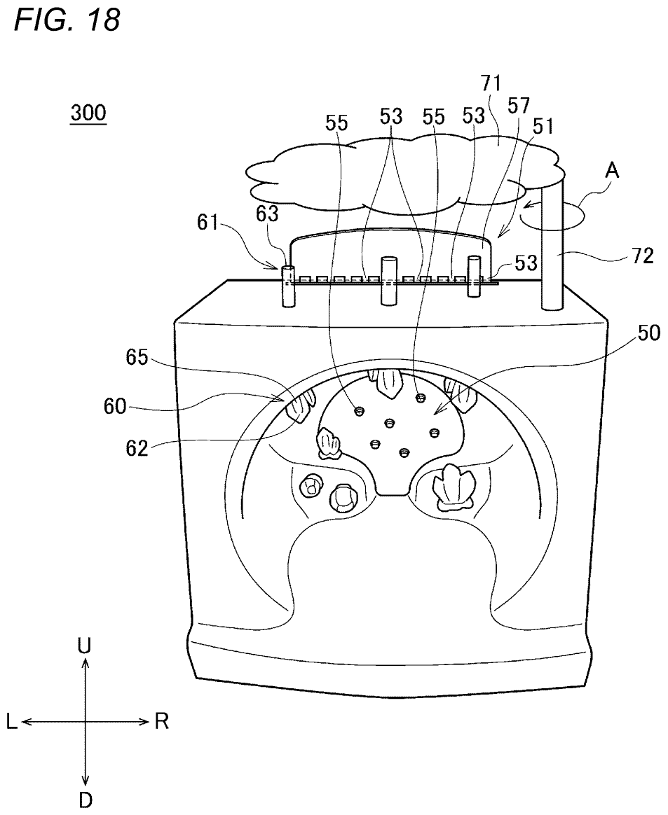

FIG. 18 is a diagram (part 1) illustrating a configuration for changing a light emission state of the lighting portions 55 and 65 illustrated in FIG. 16. As illustrated in FIG. 18, a light shielding portion 71 that shields external light incident on the light collecting portions 53 and 63 may be provided above the cave toy 300.

In the example illustrated in FIG. 18, as an example, the light shielding portion 71 has a shape imitating a cloud, and is attached to the cave toy 300 via a support portion 72 extending upward from the cave toy 300. In addition, the light shielding portion 71 is movable with respect to the light collecting portions 53 and 63. Specifically, as indicated by an arrow A in FIG. 18, the light shielding portion 71 is rotatable about the support portion 72.

FIGS. 19A and 19B are diagrams (part 2) illustrating a configuration for changing the light emission state of the lighting portion 55 or 65 illustrated in FIG. 16. FIGS. 19A and 19B illustrate a configuration for changing the light emission state of the lighting portion 65. As illustrated in FIG. 19A, when the light shielding portion 71 is not positioned above the light collecting portion 63 in the light guide body 61 due to the rotation of the light shielding portion 71, external light is incident on the light collecting portion 63, and thus the lighting portion 65 emits light. On the other hand, as illustrated in FIG. 19B, when the light shielding portion 71 is positioned above the light collecting portion 63 due to the rotation of the light shielding portion 71, the lighting portion 65 is turned off by blocking the incidence of the external light on the light collecting portion 63 by the light shielding portion 71.

In this way, it is possible to change the incident state of the external light on the light collecting portion 63 according to the movement of the light shielding portion 71. Therefore, the light emission state of the lighting portion 65 can be changed, for example, the lighting portion 65 is turned on and off to blink by rotating the light shielding portion 71.

In FIGS. 19A and 19B, the configuration for changing the light emission state of the lighting portion 65 is described, but the lighting portion 15 illustrated in FIGS. 5, 11, 12, and 13, the lighting portion 45 illustrated in FIG. 15, and the lighting portion 55 illustrated in FIG. 16 may be similarly provided with the movable light shielding portion 71 above the light collecting portions 13, 43, and 53.

### (Configuration for Causing Lighting Portion to Emit Light of Predetermined Color)

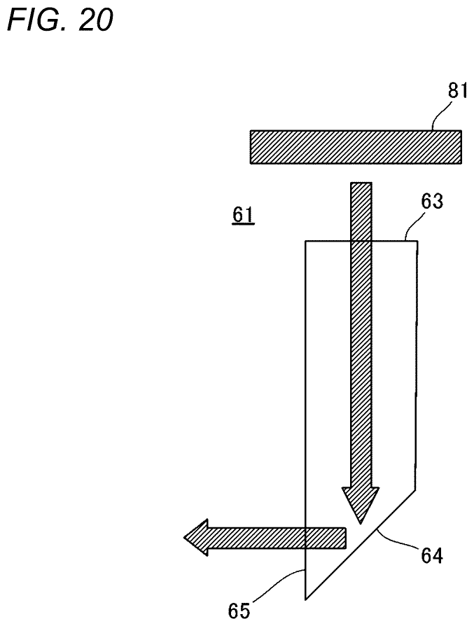

FIG. 20 is a diagram illustrating a configuration for causing the lighting portion 65 illustrated in FIG. 16 to emit light in a predetermined color. Above the cave toy 300 illustrated in FIG. 16, an auxiliary portion 81 that covers a part or a whole of the light collecting portion 63 and allows light to transmit therethrough may be provided as illustrated in FIG. 20. The auxiliary portion 81 is colored. Therefore, external light passes through the auxiliary portion 81 and is guided by the light guide body 61, so that the lighting portion 65 in the light guide body 61 emits light in the color assigned to the auxiliary portion 81.

The auxiliary portion 81 may be divided into a plurality of regions, and the regions may be colored in different colors. In this case, for example, it is possible to cause some of the plurality of jewel toys 60 positioned below the auxiliary portion 81 to emit red light and cause the other part to emit blue light, or to cause each of the jewel toys 60 to emit light in a different color.

In addition, the auxiliary portion 81 may be movable with respect to the light collecting portion 63 similarly to the light shielding portion 71 illustrated in FIG. 18. In this case, for example, the light emission color of the lighting portion 65 can be changed according to the movement of the auxiliary portion 81.

In addition, in FIG. 20, the configuration for causing the lighting portion 65 to emit light in a predetermined color is described, but the lighting portion 15 illustrated in FIGS. 5, 11, 12, and 13, the lighting portion 45 illustrated in FIG. 15, and the lighting portion 55 illustrated in FIG. 16 may be similarly provided with the colored auxiliary portion 81 above the light collecting portions 13, 43, and 53. Accordingly, the lighting portions 15, 45, and 55 can emit light in a predetermined color.

Although a plurality of types of toys including the lighting toy according to the present disclosure are described above, the lighting toy according to the present disclosure is not limited to those used in the above toys, and can also be applied to other toys imitating a light emitting instrument, such as a warm oven toy and a refrigerator toy.

As described above, the lighting toy according to the present embodiment includes a light guide body configured to guide light from outside, in which the light guide body includes a light collecting portion configured to collect the light, a reflection portion configured to reflect the light incident on the light collecting portion to change a traveling direction of the light to a predetermined direction, and a lighting portion to which the light reflected by the reflection portion reaches.

With such a configuration, it is possible to cause external light to reach a predetermined position and cause the position to emit light. Therefore, it is possible to implement a toy that emits light at a predetermined position without receiving electric power supplied from a battery. As a result, it is possible to avoid light emission failure due to battery exhaustion or the like and cost generation.

In the lighting toy according to the present embodiment, the light collecting portion has a columnar shape. The reflection portion is a surface inclined with respect to an extending direction of the light collecting portion and intersecting the extending direction. With such a configuration, the light incident on the light collecting portion can be more reliably reflected by the reflection portion.

In the lighting toy according to the present embodiment, the light guide body includes a bent portion between the light collecting portion and the lighting portion. The bent portion is bent in a bending direction. Further, the reflection portion is provided on at least a part of the bent portion on an outer side in the bending direction. With such a configuration, since the light guide body extends between the reflection portion provided on the bent portion and the lighting portion, the lighting portion can be installed at any position, and any position can emit light.

Further, in the lighting toy according to the present embodiment, the light collecting portion has a columnar shape, and an upper end is exposed. With such a configuration, light from an indoor light installed on a ceiling of a room, sunlight, or the like can be easily incident on the light collecting portion.

The lighting toy according to the present embodiment further includes a cover portion configured to cover a part or a whole of the lighting portion and allow light to transmit therethrough. In addition, the light guide body and the cover portion are formed separately. With such a configuration, it is possible to prevent light incident on the light collecting portion of the light guide body from being dispersed to both the lighting portion and the cover portion, and to secure the intensity of light in the lighting portion.

In addition, in the lighting toy according to the present embodiment, the lighting portion is provided at a position where a part of light from outside is blocked. With such a configuration, since the periphery of the lighting portion is darker than other portions, light in the lighting portion appears to be emphasized.

In the lighting toy according to the present embodiment, the light guide body includes a first end portion on a light collection portion side and a second end portion on a lighting portion side, and an area of the first end portion is equal to or larger than an area of the second end portion. With such a configuration, the intensity of the light of the lighting portion can be made larger than the intensity of the light in the light collecting portion.

The lighting toy according to the present embodiment further includes a light shielding portion configured to shield the light to the light collecting portion. The light shielding portion is movable with respect to the light collecting portion. With such a configuration, since the amount of light incident on the light collecting portion can be changed by moving the light shielding portion, it is possible to change the light emission state of the lighting portion such as blinking the lighting portion.

The lighting toy according to the present embodiment further includes an auxiliary portion configured to cover a part or a whole of the light collecting portion and allow light to transmit therethrough. The auxiliary portion 81 is colored. With such a configuration, it is possible to change the color of the light in the lighting portion by adjusting the color of the light incident on the light collecting portion.

The lighting toy according to the present embodiment is an illumination toy, and the lighting portion has a circular shape. As described above, since the lighting portion emits light in a circular shape, it is possible to make the lighting portion look like a light bulb of the lighting fixture.

Although the present embodiment has been described above, the technical scope of the present invention should not be construed as being limited by the description of the present embodiment. It should be understood by those skilled in the art that the present embodiment is an example and various modifications of the embodiment are possible within the scope of the invention described in the claims. The technical scope of the present invention should be determined based on the scope of the invention described in the claims and the equivalent scope thereof.

What is claimed is:

1. A lighting toy comprising:
a light guide body configured to guide light from an outside,
wherein the light guide body comprises:
a light collecting portion configured to collect the light;
a reflection portion configured to reflect the light incident on the light collecting portion to change a traveling direction of the light to a predetermined direction; and
a lighting portion to which the light reflected by the reflection portion reaches.

2. The lighting toy according to claim 1,
wherein the light collecting portion has a columnar shape, and
wherein the reflection portion comprises a surface inclined with respect to an extending direction of the light collecting portion and intersecting the extending direction.

3. The lighting toy according to claim 1,
wherein the light guide body comprises a bent portion between the light collecting portion and the lighting portion, the bent portion being bent in a bending direction, and
wherein the reflection portion is provided on at least a part of the bent portion on an outer side in the bending direction.

4. The lighting toy according to claim 1,
wherein the light collecting portion has a columnar shape, and
an upper end of the light collecting portion is exposed.

5. The lighting toy according to claim 1, further comprising:
a cover portion configured to cover a part or a whole of the lighting portion and allow light to transmit therethrough,
wherein the light guide body and the cover portion are formed separately.

6. The lighting toy according to claim 1,
wherein the lighting portion is provided at a position where a part of the light from the outside is blocked.

7. The lighting toy according to claim 1,
wherein the light guide body comprises a first end portion on a light collection portion side and a second end portion on a lighting portion side, and
wherein an area of the first end portion is equal to or larger than an area of the second end portion.

8. The lighting toy according to claim 1, further comprising:
a light shielding portion configured to shield the light to the light collecting portion,
wherein the light shielding portion is movable with respect to the light collecting portion.

9. The lighting toy according to claim 1, further comprising:
an auxiliary portion configured to cover a part or a whole of the light collecting portion and allow light to transmit therethrough,
wherein the auxiliary portion is colored.

10. The lighting toy according to claim 1,
wherein the lighting toy is an illumination toy, and
wherein the lighting portion has a circular shape.
